(19) United States
(12) Patent Application Publication
(10) Pub. No.: US 2026/0321055 A1
(43) Pub. Date: Oct. 15, 2026

(54) A DEEP LEARNING BASED FINGERPRINT IMAGE RECOGNITION METHOD AND SYSTEM

(71) Applicant: HANGZHOU SYNOCHIP DATA SECURITY TECHNOLOGY CO., LTD, Hangzhou, Zhejiang (CN)

(72) Inventors: Hongchang LUO, Hangzhou (CN); Feifei ZHANG, Hangzhou (CN); Junge LIANG, Hangzhou (CN)

(73) Assignee: HANGZHOU SYNOCHIP DATA SECURITY TECHNOLOGY CO., LTD, Hangzhou, Zhejiang (CN)

(21) Appl. No.: 18/994,411

(22) PCT Filed: Nov. 20, 2023
(86) PCT No.: PCT/CN2023/132697

§ 371 Date: Jan. 14, 2025

(30) Foreign Application Priority Data
Nov. 15, 2023 (CN) 202311518707.7

(51) Int. Cl. G06V 40/12; G06V 10/75; G06V 10/82

(52) U.S. Cl. CPC G06V 40/1347; G06V 10/751; G06V 10/82; G06V 40/1365

(57) ABSTRACT

A fingerprint image recognition method and system are based on deep learning. The fingerprint image recognition method package perform two deep learning models on the processed fingerprint sample data using grayscale compensation and the original fingerprint sample data training, completing the deep learning model after training. Performing grayscale compensation on the fingerprint reference image obtains a grayscale compensated fingerprint reference image and fingerprint features. The fingerprint edge performs grayscale compensation processing on the edge pixel block of the image, forming the target fingerprint image to be detected. The model obtains the fingerprint image of the target to be detected for fingerprint feature recognition, obtains the fingerprint features of the target fingerprint image to be detected, and compares the fingerprint features of the target fingerprint image to be detected with the target fingerprint features, and obtain the fingerprint image recognition result. The system includes modules corresponding to the method steps.

### TECHNICAL FIELD

The present invention relates to the field of fingerprint image recognition technology, particularly to a deep learning based fingerprint image recognition method and system.

### BACKGROUND

Fingerprint recognition technology is a type of biometric technology that compares fingerprint features with fingerprint information in a database to achieve individual identity recognition. With the development of technology, fingerprint recognition technology has been widely applied in fields such as security authentication and access control systems. However, in practical applications, due to the diversity of fingerprint samples and different collection devices, the collected fingerprint images often suffer from uneven grayscale of boundary pixel blocks, which poses challenges to the extraction and recognition of fingerprint features.

To address this issue, some studies have proposed methods for grayscale compensation processing of fingerprint images. These methods mainly improve the grayscale distribution of boundary pixel blocks by enlarging or reducing the pixel blocks of fingerprint images. However, these methods often only target a single pixel block processing method, ignoring the processing effect of pixel blocks in different situations.

In addition, for deep learning models, the quality and quantity of training data will directly affect the performance of the model. In existing technology, the training data mainly comes from the fingerprint reference images of the users that have been entered, but the quality and quantity of these images are limited, so the performance of the model is also limited.

### SUMMARY

The present invention provides a method and system for fingerprint image recognition based on deep learning, which solves the problem of low boundary clarity of fingerprint lines caused by overlapping images between adjacent fingerprint patterns due to sweat stains, water stains, or problems with image acquisition devices in the prior art, thereby affecting the accuracy of fingerprint recognition

The present invention proposes a deep learning based fingerprint image recognition method, which includes:
S1: Perform grayscale compensation on the fingerprint boundary pixel blocks of the fingerprint sample data in the database, and use the grayscale compensated fingerprint sample data and the original fingerprint sample data for two rounds of deep learning model training to complete the trained deep learning model;
S2: Perform grayscale compensation processing on the fingerprint boundary pixel blocks of the input user's fingerprint reference image, obtain the grayscale compensated fingerprint reference image, and use the deep learning model to obtain the fingerprint features of the fingerprint reference image as the target fingerprint features;
S3: When obtaining the user's fingerprint image to be detected, perform grayscale compensation processing on the edge pixel blocks of the fingerprint image to form the target fingerprint image to be detected;
S4: Input the target fingerprint image to a deep learning model, which obtains the target fingerprint image for fingerprint feature recognition, obtains the fingerprint features of the target fingerprint image, and compares the fingerprint features of the target fingerprint image with the target fingerprint features to obtain the fingerprint image recognition result.

Furthermore, the fingerprint sample data in the database is subjected to grayscale compensation processing of fingerprint boundary pixel blocks, and a deep learning model is trained twice using the grayscale compensated fingerprint sample data and the original fingerprint sample data to complete the trained deep learning model, including:
S11: Extract fingerprint sample data from the database, and use the fingerprint sample data to perform initial training on the deep learning model used for fingerprint image feature recognition, obtaining the initial deep learning model after completing the initial training;
S12: Perform pixel block enlargement and pixel block reduction on the fingerprint sample data used for initial training, and obtain the comprehensive grayscale compensation value corresponding to the fingerprint sample data used for initial training by expanding and reducing the pixel block of the fingerprint sample data;
S13: Perform grayscale compensation processing on the fingerprint boundary pixel blocks of the fingerprint sample data used for initial training through the comprehensive grayscale compensation value, and obtain adjusted sample data;
S14: Use the adjusted sample data to perform secondary training on the deep learning model and obtain the trained deep learning model;
S15: Verify the deep learning model using fingerprint validation samples to obtain the accuracy of fingerprint image feature recognition for the deep learning model;
S16: When the accuracy is below the preset accuracy threshold, optimize the deep learning model until the validated accuracy reaches or exceeds the preset accuracy threshold.

Furthermore, pixel block enlargement and pixel block reduction are performed on the fingerprint sample data used for initial training, and the comprehensive grayscale compensation value corresponding to the fingerprint sample data used for initial training is obtained by enlarging and reducing the pixel block of the fingerprint sample data, including:
S121: Perform pixel block enlargement on the fingerprint sample data used for initial training to obtain the enlarged fingerprint sample data as the first sample data; Among them, the expanded size range of the pixel block is 1.5D-3D, where D represents the size of the pixel block used for initial training of fingerprint sample data;
S122: Obtain the first grayscale compensation value based on the grayscale values of the pixel blocks in the fingerprint and background parts of the first sample data;
S123: Perform pixel block reduction on the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training;
S124: Obtain a second grayscale compensation value based on the grayscale values of the pixel blocks in the fingerprint and background parts of the second sample data;
S125: Obtain a comprehensive grayscale compensation value using the first grayscale compensation value and the second grayscale compensation value.

Furthermore, the fingerprint boundary pixel blocks of the input user's fingerprint reference image are subjected to grayscale compensation processing at the fingerprint reference image end to obtain a grayscale compensated fingerprint reference image, including:
S21: Extract the grayscale values of pixel blocks from the reference image of the user's fingerprint that has been entered;
S22: Extract comprehensive grayscale compensation value;
S23: Obtain the first grayscale compensation amount corresponding to the grayscale compensation processing at the fingerprint reference image end by using the grayscale values and comprehensive grayscale compensation values of the pixel blocks in the fingerprint reference image;
S24: Adjust the pixel values of the fingerprint boundary pixel blocks of the fingerprint reference image to the first grayscale compensation amount, forming the fingerprint reference image after grayscale compensation processing.

Furthermore, when obtaining the user's fingerprint image to be detected, performing grayscale compensation processing on the fingerprint edge pixel blocks of the fingerprint image to form the target fingerprint image to be detected, including:
S31: Extract the grayscale values of pixel blocks in the fingerprint image to be detected;
S32: Extract comprehensive grayscale compensation value;
S33: Obtain the second grayscale compensation amount corresponding to the grayscale compensation processing of the image to be detected by using the grayscale values and comprehensive grayscale compensation values of the pixel blocks of the fingerprint image to be detected;
S34: Adjust the pixel values of the fingerprint boundary pixel blocks of the fingerprint image to be detected to the second grayscale compensation amount, forming the target fingerprint image to be detected.

The present invention proposes a deep learning based fingerprint image recognition system, which comprises:
Data processing module: perform grayscale compensation on the fingerprint boundary pixel blocks of the fingerprint sample data in the database, and use the grayscale compensated fingerprint sample data and the original fingerprint sample data to train the deep learning model twice, completing the trained deep learning model;
Image acquisition module: perform grayscale compensation processing on the fingerprint boundary pixel blocks of the input user's fingerprint reference image, obtain the grayscale compensated fingerprint reference image, and use the deep learning model to obtain the fingerprint features of the fingerprint reference image as the target fingerprint features;
Image formation module: When obtaining the user's fingerprint image to be detected, perform grayscale compensation processing on the fingerprint edge pixel blocks of the fingerprint image to form the target fingerprint image to be detected;
Result acquisition module: Input the target fingerprint image to a deep learning model, which obtains the target fingerprint image for fingerprint feature recognition, obtains the fingerprint features of the target fingerprint image, and compares the fingerprint features of the target fingerprint image with the target fingerprint features to obtain the fingerprint image recognition result.

Furthermore, the data processing module comprises:
Data extraction module: Extract fingerprint sample data from the database, and use the fingerprint sample data to perform initial training on the deep learning model used for fingerprint image feature recognition, obtaining the initial deep learning model after completing the initial training;
Compensation value acquisition module: pixel block enlargement and pixel block reduction are performed on the fingerprint sample data used for initial training, and the comprehensive grayscale compensation value corresponding to the fingerprint sample data used for initial training is obtained by enlarging and reducing the pixel block of the fingerprint sample data;
Data acquisition module: using the comprehensive grayscale compensation value to perform grayscale compensation processing on the fingerprint boundary pixel blocks of the fingerprint sample data used for initial training, and obtain adjusted sample data;
Model acquisition module: Use the adjusted sample data to perform secondary training on the deep learning model and obtain the trained deep learning model;
Accuracy acquisition module: using fingerprint validation samples to validate the deep learning model and obtain the accuracy of fingerprint image feature recognition of the deep learning model;
Threshold judgment module: When the accuracy is lower than the preset accuracy threshold, optimize the deep learning model until the validated accuracy reaches or exceeds the preset accuracy threshold.

Furthermore, the compensation value acquisition module comprises:
First sample data module: pixel block enlargement is performed on the fingerprint sample data used for initial training to obtain the enlarged fingerprint sample data as the first sample data; Among them, the expanded size range of the pixel block is 1.5D-3D, where D represents the size of the pixel block used for initial training of fingerprint sample data;
The first grayscale compensation value module obtains the first grayscale compensation value based on the grayscale values of the pixel blocks in the fingerprint and background parts of the first sample data;
Second sample data module: perform pixel block reduction on the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training;
Second grayscale compensation value module: obtaining a second grayscale compensation value based on the grayscale values of pixel blocks in the fingerprint and background parts of the second sample data;
Comprehensive grayscale compensation value module: using the first grayscale compensation value and the second grayscale compensation value to obtain the comprehensive grayscale compensation value.

Furthermore, the image acquisition module comprises:
Grayscale value extraction module: Extract the grayscale values of pixel blocks in the input user's fingerprint reference image;
Compensation value extraction module: Extract comprehensive grayscale compensation values;
Gray compensation value acquisition module: obtaining the first gray compensation amount corresponding to the gray compensation processing of the fingerprint reference image end through the gray values of the pixel blocks of the fingerprint reference image and the comprehensive gray compensation value;
Pixel block adjustment module: Adjust the pixel values of the fingerprint boundary pixel blocks of the fingerprint reference image to the first grayscale compensation amount, forming a grayscale compensated fingerprint reference image.

Furthermore, the image forming module comprises:
Detection module: Extract the grayscale values of pixel blocks in the fingerprint image to be detected;
Extraction module: Extract comprehensive grayscale compensation values;
Acquisition module: Obtain the second grayscale compensation amount corresponding to the grayscale compensation processing of the image to be detected by using the grayscale values and comprehensive grayscale compensation values of the pixel blocks of the fingerprint image to be detected; Image formation module: Adjust the pixel values of the fingerprint boundary pixel blocks of the fingerprint image to the second grayscale compensation amount to form the target fingerprint image to be detected.

Beneficial effects of the present invention: By performing grayscale compensation processing on fingerprint boundary pixel blocks, the clarity and contrast of fingerprint images can be enhanced, thereby improving the accuracy of deep learning models in extracting and recognizing fingerprint features; By combining the grayscale compensated fingerprint sample data with the original fingerprint sample data during the training process of the deep learning model, the deep learning model can have good adaptability and robustness to fingerprint images in different situations; By performing grayscale compensation on the fingerprint images to be detected, the impact of poor image quality and insufficient clarity on fingerprint recognition results can be reduced, thereby improving the security and reliability of fingerprint recognition; Using deep learning models for fingerprint feature extraction and recognition can greatly improve recognition efficiency and speed, making fingerprint recognition more convenient and efficient; This fingerprint recognition scheme can be applied to various scenarios that require identity verification, such as unlocking mobile phones, access control systems, etc., and has broad application and market prospects.

Meanwhile, through the application of deep learning algorithms, the system can effectively identify and remove artifacts caused by sweat stains, water stains, or issues with image acquisition devices, thereby improving the clarity and quality of fingerprint images; Higher clarity fingerprint images will help improve the accuracy and robustness of fingerprint recognition systems, reduce misidentification rates, and increase the success rate of fingerprint recognition; Deep learning methods can learn and understand fingerprint image features in various different situations, thereby improving the system's ability to handle interference factors such as sweat stains and water stains, enabling fingerprint recognition to maintain high accuracy even in complex environments; By solving the problem of low clarity of fingerprint line boundaries, users will receive a more stable, fast, and reliable recognition experience when using fingerprint recognition systems, improving the overall user experience.

### ATTACHED IMAGE DESCRIPTION

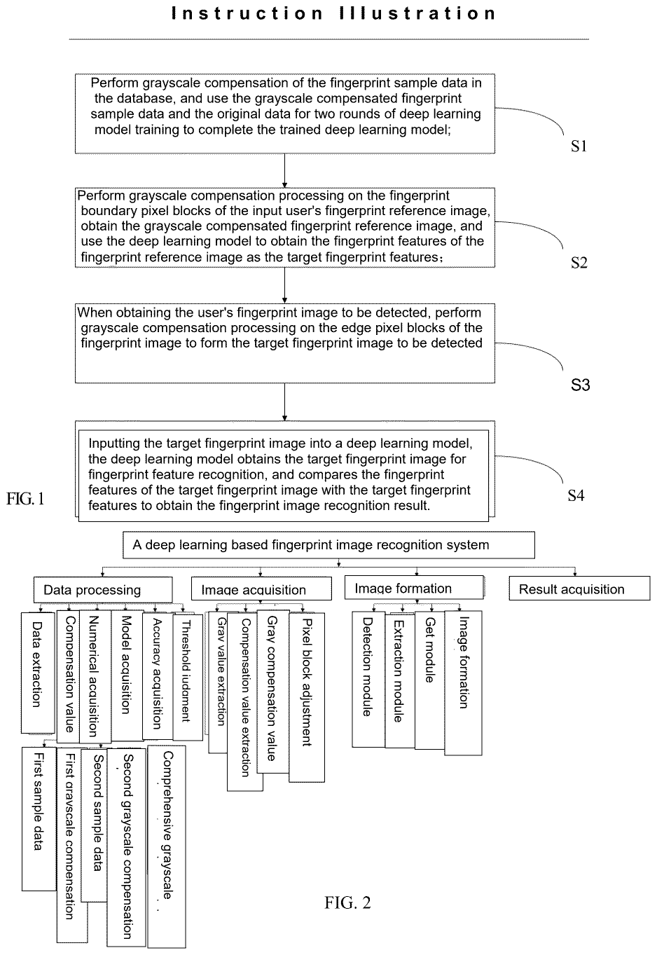

FIG. 1 shows the steps of a deep learning based fingerprint image recognition method according to the present invention;

FIG. 2 shows a module diagram of a deep learning based fingerprint image recognition system according to the present invention.

### DETAILED DESCRIPTION

The preferred embodiments of the present invention are described below in conjunction with the accompanying drawings. It should be understood that the preferred embodiments described herein are only for illustrating and explaining the present invention, and are not intended to limit the present invention.

### Example 1

This embodiment is a fingerprint image recognition method based on deep learning, which includes:
S1: Perform grayscale compensation on fingerprint boundary pixel blocks in the database, and use the grayscale compensated fingerprint sample data and the original fingerprint sample data for two rounds of deep learning model training. After completing the training deep learning models; Specifically, the deep learning model is trained twice by combining the pixel block expansion and pixel block reduction of the fingerprint sample data in the database with the grayscale compensation processing of the fingerprint boundary pixel block of the fingerprint sample data, to complete the trained deep learning model;
S2: Perform grayscale compensation processing on the fingerprint boundary pixel blocks of the input user's fingerprint reference image, obtain the grayscale compensated fingerprint reference image, and use the deep learning model to obtain the fingerprint features of the fingerprint reference image as the target fingerprint features;
S3: When obtaining the user's fingerprint image to be detected, perform grayscale compensation processing on the edge pixel blocks of the fingerprint image to form the target fingerprint image to be detected;
S4: Input the target fingerprint image to a deep learning model, which obtains the target fingerprint image for fingerprint feature recognition, obtains the fingerprint features of the target fingerprint image, and compares the fingerprint features of the target fingerprint image with the target fingerprint features to obtain the fingerprint image recognition result.
   The working principle of the above technical solution is to perform grayscale compensation processing on the fingerprint sample data in the database, and use the processed data and the original data to train the deep learning model twice. Here, two different image pixel scenarios (enlargement and reduction) are combined with fingerprint boundary pixel blocks for grayscale compensation processing to increase the robustness and generalization ability of the model; Perform grayscale compensation processing on the fingerprint boundary pixel blocks of the input user's fingerprint reference image, obtain the grayscale compensated fingerprint reference image, and extract fingerprint features as target fingerprint features through a trained deep learning model; When obtaining the user's fingerprint image to be detected, perform grayscale compensation processing on the fingerprint edge pixel blocks to form the target fingerprint image to be detected; Input the target fingerprint image to be detected into a deep learning model, which extracts the fingerprint features of the target fingerprint image and compares them with the target fingerprint features to obtain the recognition result of the fingerprint image.

The effect of the above technical solution is: by performing grayscale compensation on fingerprint sample data and using two deep learning model trainings, the model can better adapt to changes in lighting, angle, and quality, improving the robustness of fingerprint recognition and effectively dealing with complex conditions in real-world scenarios; Extracting fingerprint features using deep learning models, and obtaining fingerprint image recognition results by comparing the fingerprint features of the target fingerprint image to be detected with the target fingerprint features. Deep learning models can learn more abstract and advanced feature representations, thus improving the accuracy of fingerprint image recognition; By combining two different image pixel scenarios (enlargement and reduction) with fingerprint boundary pixel blocks for grayscale compensation processing, the model's generalization ability is increased, enabling it to better adapt to fingerprint images of different sizes and resolutions, and improving the generalization ability of fingerprint recognition;

Based on deep learning models, it has strong practicality and can be applied to various fingerprint recognition scenarios, such as access control systems, mobile phone unlocking, etc., providing users with a convenient and secure fingerprint recognition experience. Meanwhile, traditional fingerprint recognition methods often require tedious feature engineering, while deep learning models can automatically learn the features of fingerprint images, thereby reducing the difficulty and complexity of feature engineering; Deep learning models can automatically adjust model parameters to optimize model performance and accuracy, avoiding the hassle and uncertainty of manually adjusting parameters; And it can quickly perform fingerprint recognition, processing a large amount of fingerprint image data in a short period of time, making fingerprint recognition more real-time and efficient; The training and inference of deep learning models can be carried out on general computer hardware without the need for specialized fingerprint recognition devices, thereby reducing the cost and threshold of fingerprint recognition; Deep learning models can be trained and optimized for different user groups to adapt to their needs and characteristics, thereby achieving personalized customization effects. By reducing the false recognition rate and improving anti-interference ability, the overall security of the fingerprint recognition system has been improved, reducing the possibility of illegal access.

### Example 2

In this embodiment, the fingerprint sample data in the database is subjected to grayscale compensation processing of fingerprint boundary pixel blocks, and a deep learning model is trained twice using the grayscale compensated fingerprint sample data and the original fingerprint sample data to complete the trained deep learning model, including:
S11: Extract fingerprint sample data from the database, and use the fingerprint sample data to perform initial training on the deep learning model used for fingerprint image feature recognition, obtaining the initial deep learning model after completing the initial training; Among them, the deep learning model adopts a model with a convolutional neural network structure;
S12: Perform pixel block enlargement and pixel block reduction on the fingerprint sample data used for initial training, and obtain the comprehensive grayscale compensation value corresponding to the fingerprint sample data used for initial training by expanding and reducing the pixel block of the fingerprint sample data;
S13: Perform grayscale compensation processing on the fingerprint boundary pixel blocks of the fingerprint sample data used for initial training through the comprehensive grayscale compensation value, and obtain adjusted sample data; Specifically, using the first grayscale compensation value and the second grayscale compensation value to obtain a comprehensive grayscale compensation value, and using the comprehensive data compensation value to perform grayscale compensation processing on the fingerprint boundary pixel block of the fingerprint sample data used for initial training, so that the grayscale value of the fingerprint boundary pixel block reaches the comprehensive grayscale compensation value;
S14: Use the adjusted sample data to perform secondary training on the deep learning model and obtain the trained deep learning model;
S15: Verify the deep learning model using fingerprint validation samples to obtain the accuracy of fingerprint image feature recognition for the deep learning model;
S16: When the accuracy is below the preset accuracy threshold, optimize the deep learning model until the validated accuracy reaches or exceeds the preset accuracy threshold.

The working principle of the above technical solution is to extract fingerprint sample data from the database, and use the fingerprint sample data to perform initial training on the deep learning model used for fingerprint image feature recognition, obtaining the initial deep learning model after completing the initial training; Among them, the deep learning model adopts a model with a convolutional neural network structure; Perform pixel block enlargement and pixel block reduction on the fingerprint sample data used for initial training, and increase and decrease the number of fingerprint samples after pixel block enlargement and reduction Obtain the comprehensive grayscale compensation value corresponding to the fingerprint sample data used for initial training; By using the comprehensive grayscale compensation value to perform grayscale compensation processing on the fingerprint boundary pixel blocks of the fingerprint sample data used for initial training, the adjusted sample data is obtained; Specifically, using the first grayscale compensation value and the second grayscale compensation value to obtain a comprehensive grayscale compensation value, and using the comprehensive data compensation value to perform grayscale compensation processing on the fingerprint boundary pixel block of the fingerprint sample data used for initial training, so that the grayscale value of the fingerprint boundary pixel block reaches the comprehensive grayscale compensation value; Using the adjusted sample data to perform secondary training on the deep learning model and obtain the trained deep learning model; Using fingerprint validation samples to validate the deep learning model and obtain the accuracy of fingerprint image feature recognition of the deep learning model; When the accuracy is lower than the preset accuracy threshold, optimize the deep learning model until the validated accuracy reaches or exceeds the preset accuracy threshold.

The effect of the above technical solution is that by performing grayscale compensation on the fingerprint boundary pixel blocks, the grayscale values of the fingerprint boundary pixel blocks can reach the comprehensive grayscale compensation value, thereby better adapting to the characteristics of the fingerprint image during the deep learning model training process and improving the accuracy of fingerprint image feature recognition; By performing comprehensive grayscale compensation processing on fingerprint sample data, the robustness of the model to different lighting conditions, fingerprint quality differences, and other factors can be enhanced, improving the stability and reliability of the fingerprint recognition system in practical applications; The technical solution includes monitoring and optimization mechanisms for model validation accuracy. When the validated accuracy is below a preset threshold, the deep learning model can be optimized to adapt to the characteristics of different datasets, thereby improving the applicability and performance of the system in practical applications; Through secondary model training, the model can better adapt to the adjusted sample data, improve its generalization ability, and achieve good recognition performance when processing new fingerprint sample data. By enlarging and reducing the pixel blocks of fingerprint sample data, and using comprehensive grayscale compensation values to perform grayscale compensation processing on fingerprint boundary pixel blocks, the clarity and contrast of fingerprint images can be enhanced, thereby improving the accuracy of deep learning models in extracting and recognizing fingerprint features; By performing grayscale compensation on the fingerprint images to be detected, the impact of poor image quality and insufficient clarity on fingerprint recognition results can be reduced, thereby improving the security and reliability of fingerprint recognition; Using deep learning models for fingerprint feature extraction and recognition can greatly improve recognition efficiency and speed, making fingerprint recognition more convenient and efficient. When the accuracy of a deep learning model falls below a preset accuracy threshold, it can be automatically optimized until the validated accuracy reaches or exceeds the preset accuracy threshold, thereby ensuring the performance and accuracy of the deep learning model

### Example 3

In this embodiment, pixel block enlargement and pixel block reduction are performed on the fingerprint sample data used for initial training, and the comprehensive grayscale compensation value corresponding to the fingerprint sample data used for initial training is obtained by enlarging and reducing the pixel block of the fingerprint sample data, including:
S121: Perform pixel block enlargement on the fingerprint sample data used for initial training to obtain the enlarged fingerprint sample data as the first sample data; Among them, the expanded size range of the pixel block is 1.5D-3D, where D represents the size of the pixel block of the fingerprint sample data used for initial training;
S122: Obtain the first grayscale compensation value based on the grayscale values of the pixel blocks in the fingerprint and background parts of the first sample data; Among them, the first grayscale compensation value is obtained through the following formula:

$${H}_{xa} = ln ( 1 + {H}_{x 2} - {H}_{x 1} )$$

$${H}_{x 1} = Sqrt [ \frac{1}{n} \cdot {\sum }_{i = 1}^{n} {( \frac{{H}_{di} - {H}_{b}}{{H}_{di}} - \frac{1}{n} \cdot {\sum }_{i = 1}^{n} \frac{{H}_{di} - {H}_{b}}{{H}_{di}} )}^{2} ]$$

$${H}_{x 2} = Sqrt [ \frac{1}{m} \cdot {\sum }_{i = 1}^{m} {( \frac{{H}_{yi} - {H}_{b}}{{H}_{yi}} - \frac{1}{m} \cdot {\sum }_{i = 1}^{n} \frac{{H}_{yi} - {H}_{b}}{{H}_{yi}} )}^{2} ]$$

Among them, Hxa represents the first grayscale compensation value; Hx1 And Hx2 respectively represent the first compensation component and the second compensation component; M represents the number of pixel blocks after the size of the pixel block is enlarged; N represents the number of pixel blocks before the size of the pixel block is enlarged; Hdi represents the grayscale value of the i-th pixel block after the size of the pixel block is enlarged; Hyi represents the grayscale value of the i-th pixel block before the size of the pixel block is enlarged; Hb represents the average grayscale value of pixel blocks in the background area; SQRT stands for root opening operation;
S123: Perform pixel block reduction on the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training;
S124: Obtain a second grayscale compensation value based on the grayscale values of the pixel blocks in the fingerprint and background parts of the second sample data; Among them, the second grayscale compensation value is obtained through the following formula:

$${H}_{xb} = ln ( 1 + {H}_{x 3} - {H}_{x 2} )$$

$${H}_{x 3} = Sqrt [ \frac{1}{k} \cdot {\sum }_{i = 1}^{k} {( \frac{{H}_{si} - {H}_{b}}{{H}_{si}} - \frac{1}{n} \cdot {\sum }_{i = 1}^{k} \frac{{H}_{si} - {H}_{b}}{{H}_{si}} )}^{2} ]$$

Among them, Hxb represents the second grayscale compensation value; Hx3 represents the third compensation component; K represents the number of pixel blocks after the size of the pixel block is reduced; Hsi represents the grayscale value of the i-th pixel block after the size of the pixel block is reduced;
S125: Obtain a comprehensive grayscale compensation value using the first grayscale compensation value and the second grayscale compensation value. Among them, the comprehensive grayscale compensation value is obtained through the following formula:

$${H}_{z} = ( 1 + \frac{{H}_{xb} - {H}_{xa}}{max ( {H}_{xb} , {H}_{xa} )} ) \cdot {H}_{p}$$

Among them, Hz represents the comprehensive grayscale compensation value; Hp represents the average grayscale value of the fingerprint portion of each fingerprint sample data.

The working principle of the above technical solution is to enlarge the pixel blocks of the fingerprint sample data used for initial training, and obtain the enlarged fingerprint sample data as the first sample data; Among them, the expanded size range of the pixel block is 1.5D-3D, where D represents the size of the pixel block used for initial training of fingerprint sample data; Obtain the first grayscale compensation value based on the grayscale values of the pixel blocks in the fingerprint and background parts of the first sample data; Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training; Obtain a second grayscale compensation value based on the grayscale values of pixel blocks in the fingerprint and background parts of the second sample data; Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training; Obtain a second grayscale compensation value based on the grayscale values of pixel blocks in the fingerprint and background parts of the second sample data; Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training; Obtain a second grayscale compensation value based on the grayscale values of pixel blocks in the fingerprint and background parts of the second sample data; Obtain a comprehensive grayscale compensation value using the first grayscale compensation value and the second grayscale compensation value.

The effect of the above technical solution is that by changing the pixel block size as described above, the comprehensive grayscale compensation value can be obtained, which can effectively improve the accuracy of obtaining the comprehensive grayscale compensation value. By performing pixel block enlargement and reduction operations on fingerprint sample data, fingerprint image information at different scales can be obtained, enabling the system to capture the features and details of fingerprint images more comprehensively; By calculating the first grayscale compensation value and the second grayscale compensation value, the grayscale differences between the fingerprint and background parts at different scales are compensated for, thereby more accurately describing the grayscale features of the fingerprint image at different scales; By using the first grayscale compensation value and the second grayscale compensation value, the comprehensive grayscale compensation value is calculated, which can comprehensively consider the grayscale features of fingerprint images at different scales, and improve the adaptability of the fingerprint recognition system to various scales of fingerprint images; By comprehensively utilizing multi-scale information and grayscale compensation values, the fingerprint recognition system has stronger robustness and accuracy when facing factors such as different scales and lighting conditions, which improves the practical application value of the system; By performing multi-scale processing on the initial training fingerprint sample data, more comprehensive and diverse data support can be provided for model training, which helps to improve the generalization ability and accuracy of fingerprint recognition systems. The above first grayscale compensation value formula considers multi-scale factors and grayscale value differences, comprehensively considers the grayscale features of the fingerprint and background parts, enhances the processing ability and accuracy of multi-scale fingerprint images, and helps to improve the robustness and accuracy of fingerprint recognition systems. At the same time, the first compensation component and the second compensation component in the formula respectively consider the difference in grayscale values before and after pixel block size expansion. By comparing the grayscale values of pixel blocks of different sizes, the grayscale changes of the fingerprint and background parts are more comprehensively described; The m and n parameters in the formula represent the number of pixel blocks after enlarging and reducing the pixel block size, respectively. By considering the grayscale values of pixel blocks at different scales, the grayscale compensation value can fully integrate the fingerprint image information at different scales, improving the system's processing capability for multi-scale fingerprint images; The Hb parameter in the formula represents the average grayscale value of the pixel blocks in the background. By introducing the grayscale value of the background into the calculation, the grayscale features of the fingerprint and background can be better distinguished, enhancing the accuracy of the grayscale compensation value. The sqrt operation in the formula is used to amplify and balance the differences in grayscale values, so that the grayscale compensation value can better reflect the grayscale changes at different scales, and improve the sensitivity of fingerprint image grayscale features. The above second grayscale compensation value calculation formula comprehensively considers multi-scale factors and grayscale value differences. By processing pixel block grayscale values at different scales, it enhances the processing capability and accuracy of multi-scale fingerprint images, which helps to improve the robustness and accuracy of fingerprint recognition systems. Meanwhile, the third compensation component Hx3 in the formula takes into account the difference in grayscale values after reducing the size of pixel blocks. By processing the grayscale values of the reduced size pixel blocks, it provides a more comprehensive description of the grayscale changes between the fingerprint and background parts. The k parameter in the formula represents the number of pixel blocks after reducing the pixel block size. By considering the grayscale values of pixel blocks at different scales, the second grayscale compensation value can fully integrate fingerprint image information at different scales, improving the system's processing capability for multi-scale fingerprint images. The Hsi parameter in the formula represents the grayscale value of the i-th pixel block after reducing the size of the pixel block. By processing the grayscale value of the reduced size pixel block, the second grayscale compensation value can better reflect the grayscale changes at different scales, enhancing sensitivity to the grayscale features of fingerprint images. The above comprehensive grayscale compensation value formula comprehensively considers the grayscale characteristics of fingerprint sample data, processes the grayscale information of fingerprint images globally, reduces the impact of individual samples on the system, helps improve the processing ability and accuracy of fingerprint recognition systems for different fingerprint samples, and enhances the robustness of the system. Meanwhile, the Hp parameter in the formula represents the average grayscale value of the fingerprint part of each fingerprint sample data. By introducing the average grayscale value of each fingerprint sample data, the comprehensive grayscale compensation value can consider the grayscale feature differences between different fingerprint samples, thereby enhancing the processing capability for different fingerprint samples. The comprehensive grayscale compensation value Hz processes the average grayscale value of the fingerprint part of each fingerprint sample data, taking into account the grayscale characteristics of the entire fingerprint image, so that the comprehensive grayscale compensation value can more comprehensively describe the grayscale changes between the fingerprint part and the background part. By introducing the average grayscale value of each fingerprint sample data, the formula can effectively process the grayscale features of individual samples, reduce the impact of individual samples on the entire system, and improve the stability and robustness of the system.

### Example 4

In this embodiment, the fingerprint boundary pixel blocks of the input user's fingerprint reference image are subjected to grayscale compensation processing at the fingerprint reference image end to obtain a grayscale compensated fingerprint reference image, including:
S21: Extract the grayscale values of pixel blocks from the reference image of the user's fingerprint that has been entered; S22: Extract comprehensive grayscale compensation value;
S23: Obtain the first grayscale compensation amount corresponding to the grayscale compensation processing at the fingerprint reference image end by using the grayscale values and comprehensive grayscale compensation values of the pixel blocks in the fingerprint reference image; Among them, the first grayscale compensation amount is obtained through the following formula:

$${H}_{01} = ( 1 + \frac{1}{r \cdot {λ}_{1}} \cdot {\sum }_{i = 1}^{r} \frac{{H}_{ri} - {H}_{z}}{max ( {H}_{ri} , {H}_{z} )} ) \cdot {H}_{z}$$

$${λ}_{1} = 1 + \sqrt{\frac{1.312 \times {C}_{1}}{{C}_{2}}}$$

Among them, H01 represents the first grayscale compensation amount; R represents the number of pixel blocks in the fingerprint reference image; Hri represents the grayscale value of the i-th pixel block in the fingerprint reference image; Hz represents the comprehensive grayscale compensation value; C1 represents the number of pixel blocks in the fingerprint portion of the fingerprint reference image; C2 represents the number of pixel blocks in the background of the fingerprint reference image; λ1 represents the first adjustment coefficient;
S24: Adjust the pixel values of the fingerprint boundary pixel blocks of the fingerprint reference image to the first grayscale compensation amount, forming the fingerprint reference image after grayscale compensation processing.

The working principle of the above technical solution is to extract the grayscale values of pixel blocks in the reference image of the user's fingerprint that has been entered; The system will process the input user's fingerprint reference image, segment the image into different pixel blocks, and extract the grayscale value of each pixel block. These grayscale values reflect the brightness or grayscale level of each region in the fingerprint image; The extraction of comprehensive grayscale compensation values may involve analyzing the entire fingerprint reference image to determine the overall grayscale features and compensation requirements. This value may be calculated based on factors such as overall brightness and contrast of the image, and used for subsequent grayscale compensation processing. By combining the grayscale values of pixel blocks in the fingerprint reference image with the comprehensive grayscale compensation value, the system calculates the first grayscale compensation amount, which is usually used for grayscale adjustment of the entire image to achieve overall grayscale

The effect of the above technical solution is that by performing grayscale compensation processing on the fingerprint reference image, it can effectively reduce interference caused by external factors such as lighting conditions and influences, thereby improving the accuracy and robustness of fingerprint recognition; Grayscale compensation processing can help highlight and enhance features in fingerprint images, making them more discriminative and thus improving the reliability of fingerprint recognition; By adjusting the pixel values of the fingerprint reference image, grayscale compensation processing helps optimize the quality of the fingerprint image, making it clearer, easier to analyze, and recognize; The extraction of comprehensive grayscale compensation values and the adjustment of grayscale compensation amounts can be adjusted according to different environmental conditions and requirements, enabling the fingerprint recognition system to better adapt to different work scenarios.

By using the first grayscale compensation calculation formula mentioned above, the calculation of grayscale compensation can be made more intelligent and personalized, which can better adapt to the characteristics of different fingerprint images and improve the performance of the entire fingerprint recognition system. Meanwhile, the above formula can be personalized and adjusted based on the specific features of the fingerprint reference image. By considering the number of pixel blocks in the fingerprint and background parts, the formula can compensate for the grayscale features of different parts to varying degrees, in order to adapt to the characteristics of different fingerprint images. The formula includes a comprehensive grayscale compensation value Hz, which enables the calculation of grayscale compensation to comprehensively consider the grayscale features of the entire fingerprint image, rather than being limited to the grayscale values of local areas. This can comprehensively adjust the grayscale of the image and improve the quality of the fingerprint image. The introduction of the adjustment coefficient λ1 makes the calculation of the grayscale compensation amount in the formula adjustable, and the parameters can be adjusted according to the actual situation to obtain the best grayscale compensation effect. Through this personalized, comprehensive and adjustable grayscale compensation calculation, the grayscale of the fingerprint reference image can be more accurately adjusted, thereby improving the accuracy and robustness of the fingerprint recognition system to fingerprint images.

### Example 5

In this embodiment, when obtaining the user's fingerprint image to be detected, the edge pixel blocks of the fingerprint image to be detected are subjected to grayscale compensation processing at the image end to form the target fingerprint image to be detected, including:
S31: Extract the grayscale values of pixel blocks in the fingerprint image to be detected;
S32: Extract comprehensive grayscale compensation value;
S33: Obtain the second grayscale compensation amount corresponding to the grayscale compensation processing of the image to be detected by using the grayscale values and comprehensive grayscale compensation values of the pixel blocks of the fingerprint image to be detected; Among them, the second grayscale compensation amount is obtained by the following formula:

$${H}_{02} = ( 1 + \frac{1}{r \cdot {λ}_{2}} \cdot {\sum }_{i = 1}^{r} \frac{{H}_{ri} - {H}_{z}}{max ( {H}_{ri} , {H}_{z} )} ) \cdot {H}_{z}$$

$${λ}_{2} = 1 + \sqrt{\frac{1.126 \times {C}_{3}}{{C}_{4}}}$$

Among them, H02 represents the second grayscale compensation amount; T represents the number of pixel blocks in the fingerprint image to be detected; Hti represents the grayscale value of the i-th pixel block of the fingerprint image to be detected; Hz represents the comprehensive grayscale compensation value; C3 represents the number of pixel blocks in the fingerprint portion of the fingerprint image to be detected; C4 represents the number of pixel blocks in the background of the fingerprint image to be detected; λ2 represents the second adjustment coefficient.
S34: Adjust the pixel values of the fingerprint boundary pixel blocks of the fingerprint image to be detected to the second grayscale compensation amount, forming the target fingerprint image to be detected.

The working principle of the above technical solution is to perform pixel block segmentation on the fingerprint image to be detected, with each pixel block containing a certain number of pixels. Then, extract the grayscale values of these pixel blocks. The grayscale value represents the color information of each pixel, ranging from 0 to 255, where 0 represents black and 255 represents white. This process is to obtain the brightness information of each pixel in the image; The extraction of comprehensive grayscale compensation values is to consider the brightness and contrast of the entire image. By processing various statistical features such as the average grayscale value, maximum and minimum grayscale values of the entire image. The comprehensive grayscale compensation value aims to provide reference for the subsequent grayscale compensation processing; By processing the grayscale values and comprehensive grayscale compensation values of the pixel blocks in the fingerprint image to be detected, the second grayscale compensation amount corresponding to the grayscale compensation processing of the image to be detected is obtained. This process usually involves some mathematical operations, such as addition, subtraction, multiplication, etc., to correct the grayscale value of each pixel; Adjust the pixel values of the fingerprint boundary pixel blocks in the fingerprint image to be detected to the second grayscale compensation amount.

The effect of the above technical solution is that by performing grayscale compensation processing on the fingerprint edge pixel blocks of the target fingerprint image to be detected, the grayscale values of the edge regions can be extracted, thereby enhancing the information of the fingerprint edges and making the boundaries of the target fingerprint image to be detected clearer and more accurate; By extracting the comprehensive grayscale compensation value and combining it with the grayscale values of the pixel blocks in the fingerprint image to be detected, the second grayscale compensation amount corresponding to the grayscale compensation processing on the image side can be calculated. This can achieve a balanced distribution of local grayscale in fingerprint images, resulting in smaller brightness differences and better visual effects for the entire image; Adjusting the pixel values of the fingerprint boundary pixel blocks in the fingerprint image to be detected to the second grayscale compensation amount can effectively correct the grayscale differences in the edge area, further enhancing the quality and clarity of the target fingerprint image to be detected, and providing more accurate input for subsequent fingerprint recognition.

The above formula combines the pixel block grayscale values, comprehensive grayscale compensation values, and adjustment coefficients of the fingerprint image to be detected. It can personalize grayscale compensation, adjust grayscale distribution, distinguish background and fingerprint, and flexibly control the grayscale compensation effect through adjustment coefficients, thereby improving the quality and reliability of the target fingerprint image to be detected. Meanwhile, the above formula is based on the grayscale values of the pixel blocks in the fingerprint image to be detected. Hti in the formula represents the grayscale value of each pixel block. By summing up all pixel blocks and dividing by the number of pixel blocks t, the average grayscale value can be obtained. This can more accurately reflect the grayscale features of the entire fingerprint image, thereby achieving personalized grayscale compensation; The comprehensive grayscale compensation value Hz plays a role in adjusting the grayscale distribution in the formula. By comprehensively considering the local grayscale features and overall grayscale compensation values of the fingerprint image to be detected, appropriate grayscale adjustments can be made to different regions according to specific situations, thereby improving the visual effect of the entire image; C3 and C4 in the formula respectively represent the number of pixel blocks in the fingerprint and background parts of the fingerprint image to be detected. By considering the influence of the background in the calculation, it is possible to better distinguish between fingerprints and backgrounds, further improving the clarity and recognizability of the target fingerprint image to be detected; The adjustment coefficient λ2 plays a role in adjusting the grayscale compensation amount in the formula. By adjusting the values of the coefficients, the intensity and effect of grayscale compensation can be flexibly controlled to meet different practical application needs.

### Example 6

This embodiment is a deep learning based fingerprint image recognition system, which includes:
Data processing module: perform grayscale compensation on the fingerprint boundary pixel blocks of the fingerprint sample data in the database, and use the grayscale compensated fingerprint sample data and the original fingerprint sample data to train the deep learning model twice, completing the trained deep learning model; Specifically, the deep learning model is trained twice by combining the pixel block expansion and pixel block reduction of the fingerprint sample data in the database with the grayscale compensation processing of the fingerprint boundary pixel block of the fingerprint sample data, to complete the trained deep learning model;
Image acquisition module: perform grayscale compensation processing on the fingerprint boundary pixel blocks of the input user's fingerprint reference image, obtain the grayscale compensated fingerprint reference image, and use the deep learning model to obtain the fingerprint features of the fingerprint reference image as the target fingerprint features;
Image formation module: When obtaining the user's fingerprint image to be detected, perform grayscale compensation processing on the fingerprint edge pixel blocks of the fingerprint image to form the target fingerprint image to be detected;
Result acquisition module: Input the target fingerprint image to a deep learning model, which obtains the target fingerprint image for fingerprint feature recognition, obtains the fingerprint features of the target fingerprint image, and compares the fingerprint features of the target fingerprint image with the target fingerprint features to obtain the fingerprint image recognition result.

The working principle of the above technical solution is to perform grayscale compensation processing on the fingerprint sample data in the database, and use the processed data and the original data to train the deep learning model twice. Here, two different image pixel scenarios (enlargement and reduction) are combined with fingerprint boundary pixel blocks for grayscale compensation processing to increase the robustness and generalization ability of the model; Perform grayscale compensation processing on the fingerprint boundary pixel blocks of the input user's fingerprint reference image, obtain the grayscale compensated fingerprint reference image, and extract fingerprint features as target fingerprint features through a trained deep learning model; When obtaining the user's fingerprint image to be detected, perform grayscale compensation processing on the fingerprint edge pixel blocks to form the target fingerprint image to be detected; Input the target fingerprint image to be detected into a deep learning model, which extracts the fingerprint features of the target fingerprint image and compares them with the target fingerprint features to obtain the recognition result of the fingerprint image. The effect of the above technical solution is: by performing grayscale compensation on fingerprint sample data and using two deep learning model trainings, the model can better adapt to changes in lighting, angle, and quality, improving the robustness of fingerprint recognition and effectively dealing with complex conditions in real-world scenarios; Extracting fingerprint features using deep learning models, and obtaining fingerprint image recognition results by comparing the fingerprint features of the target fingerprint image to be detected with the target fingerprint features. Deep learning models can learn more abstract and advanced feature representations, thus improving the accuracy of fingerprint image recognition; By combining two different image pixel scenarios (enlargement and reduction) with fingerprint boundary pixel blocks for grayscale compensation processing, the model's generalization ability is increased, enabling it to better adapt to fingerprint images of different sizes and resolutions, and improving the generalization ability of fingerprint recognition; Based on deep learning models, it has strong practicality and can be applied to various fingerprint recognition scenarios, such as access control systems, mobile phone unlocking, etc., providing users with a convenient and secure fingerprint recognition experience. Meanwhile, traditional fingerprint recognition methods often require tedious feature engineering, while deep learning models can automatically learn the features of fingerprint images, thereby reducing the difficulty and complexity of feature engineering; Deep learning models can automatically adjust model parameters to optimize model performance and accuracy, avoiding the hassle and uncertainty of manually adjusting parameters; And it can quickly perform fingerprint recognition, processing a large amount of fingerprint image data in a short period of time, making fingerprint recognition more real-time and efficient; The training and inference of deep learning models can be carried out on general computer hardware without the need for specialized fingerprint recognition devices, thereby reducing the cost and threshold of fingerprint recognition; Deep learning models can be trained and optimized for different user groups to adapt to their needs and characteristics, thereby achieving personalized customization effects. By reducing the false recognition rate and improving anti-interference ability, the overall security of the fingerprint recognition system has been improved, reducing the possibility of illegal access.

### Example 7

In this embodiment, the data processing module comprises:
Data extraction module: Extract fingerprint sample data from the database, and use the fingerprint sample data to perform initial training on the deep learning model used for fingerprint image feature recognition, obtaining the initial deep learning model after completing the initial training; Among them, the deep learning model adopts a model with a neural network structure;
Compensation value acquisition module: pixel block enlargement and pixel block reduction are performed on the fingerprint sample data used for initial training, and the comprehensive grayscale compensation value corresponding to the fingerprint sample data used for initial training is obtained by enlarging and reducing the pixel block of the fingerprint sample data;
Data acquisition module: using the comprehensive grayscale compensation value to perform grayscale compensation processing on the fingerprint boundary pixel blocks of the fingerprint sample data used for initial training, and obtain adjusted sample data; Specifically, using the first grayscale compensation value and the second grayscale compensation value to obtain a comprehensive grayscale compensation value, and using the comprehensive data compensation value to perform grayscale compensation processing on the fingerprint boundary pixel block of the fingerprint sample data used for initial training, so that the grayscale value of the fingerprint boundary pixel block reaches the comprehensive grayscale compensation value;
Model acquisition module: Use the adjusted sample data to perform secondary training on the deep learning model and obtain the trained deep learning model;
Accuracy acquisition module: using fingerprint validation samples to validate the deep learning model and obtain the accuracy of fingerprint image feature recognition of the deep learning model;
Threshold judgment module: When the accuracy is lower than the preset accuracy threshold, optimize the deep learning model until the validated accuracy reaches or exceeds the preset accuracy threshold.

The working principle of the above technical solution is to extract fingerprint sample data from the database, and use the fingerprint sample data to perform initial training on the deep learning model used for fingerprint image feature recognition, obtaining the initial deep learning model after completing the initial training; Among them, the deep learning model adopts a model with a convolutional neural network structure; Perform pixel block enlargement and pixel block reduction on the fingerprint sample data used for initial training, and obtain the comprehensive grayscale compensation value corresponding to the fingerprint sample data used for initial training by expanding and reducing the pixel block of the fingerprint sample data; By using the comprehensive grayscale compensation value to perform grayscale compensation processing on the fingerprint boundary pixel blocks of the fingerprint sample data used for initial training, the adjusted sample data is obtained; Specifically, using the first grayscale compensation value and the second grayscale compensation value to obtain a comprehensive grayscale compensation value, and using the comprehensive data compensation value to perform grayscale compensation processing on the fingerprint boundary pixel block of the fingerprint sample data used for initial training, so that the grayscale value of the fingerprint boundary pixel block reaches the comprehensive grayscale compensation value; Using the adjusted sample data to perform secondary training on the deep learning model and obtain the trained deep learning model; Using fingerprint validation samples to validate the deep learning model and obtain the accuracy of fingerprint image feature recognition of the deep learning model; When the accuracy is lower than the preset accuracy threshold, optimize the deep learning model until the validated accuracy reaches or exceeds the preset accuracy threshold.

The effect of the above technical solution is that by performing grayscale compensation on the fingerprint boundary pixel blocks, the grayscale values of the fingerprint boundary pixel blocks can reach the comprehensive grayscale compensation value, thereby better adapting to the characteristics of the fingerprint image during the deep learning model training process and improving the accuracy of fingerprint image feature recognition; By performing comprehensive grayscale compensation processing on fingerprint sample data, the robustness of the model to different lighting conditions, fingerprint quality differences, and other factors can be enhanced, improving the stability and reliability of the fingerprint recognition system in practical applications; The technical solution includes monitoring and optimization mechanisms for model validation accuracy. When the validated accuracy is below a preset threshold, the deep learning model can be optimized to adapt to the characteristics of different datasets, thereby improving the applicability and performance of the system in practical applications; Through secondary model training, the model can better adapt to the adjusted sample data, improve its generalization ability, and achieve good recognition performance when processing new fingerprint sample data. By enlarging and reducing the pixel blocks of fingerprint sample data, and using comprehensive grayscale compensation values to perform grayscale compensation processing on fingerprint boundary pixel blocks, the clarity and contrast of fingerprint images can be enhanced, thereby improving the accuracy of deep learning models in extracting and recognizing fingerprint features; By performing grayscale compensation on the fingerprint images to be detected, the impact of poor image quality and insufficient clarity on fingerprint recognition results can be reduced, thereby improving the security and reliability of fingerprint recognition; Using deep learning models for fingerprint feature extraction and recognition can greatly improve recognition efficiency and speed, making fingerprint recognition more convenient and efficient. When the accuracy of a deep learning model falls below a preset accuracy threshold, it can be automatically optimized until the validated accuracy reaches or exceeds the preset accuracy threshold, thereby ensuring the performance and accuracy of the deep learning model.

### Example 8

In this embodiment, the compensation value acquisition module includes:
First sample data module: pixel block enlargement is performed on the fingerprint sample data used for initial training to obtain the enlarged fingerprint sample data as the first sample data; Among them, the expanded size range of the pixel block is 1.5D-3D, where D represents the size of the pixel block used for initial training of fingerprint sample data;
The first grayscale compensation value module obtains the first grayscale compensation value based on the grayscale values of the pixel blocks in the fingerprint and background parts of the first sample data; Among them, the first grayscale compensation value is obtained through the following formula:

$${H}_{xa} = ln ( 1 + {H}_{x 2} - {H}_{x 1} )$$

$${H}_{x 1} = Sqrt [ \frac{1}{n} \cdot {\sum }_{i = 1}^{n} {( \frac{{H}_{di} - {H}_{b}}{{H}_{di}} - \frac{1}{n} \cdot {\sum }_{i = 1}^{n} \frac{{H}_{di} - {H}_{b}}{{H}_{di}} )}^{2} ]$$

$${H}_{x 2} = Sqrt [ \frac{1}{m} \cdot {\sum }_{i = 1}^{m} {( \frac{{H}_{yi} - {H}_{b}}{{H}_{yi}} - \frac{1}{m} \cdot {\sum }_{i = 1}^{n} \frac{{H}_{yi} - {H}_{b}}{{H}_{yi}} )}^{2} ]$$

Among them, Hxa represents the first grayscale compensation value; Hx1 And Hx2 respectively represent the first compensation component and the second compensation component; M represents the number of pixel blocks after the size of the pixel block is enlarged; N represents the number of pixel blocks before the size of the pixel block is enlarged; Hdi represents the grayscale value of the i-th pixel block after the size of the pixel block is enlarged; Hyi represents the grayscale value of the i-th pixel block before the size of the pixel block is enlarged; Hb represents the average grayscale value of pixel blocks in the background area; SQRT stands for root opening operation;
Second sample data module: perform pixel block reduction on the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training;
Second grayscale compensation value module: obtaining a second grayscale compensation value based on the grayscale values of pixel blocks in the fingerprint and background parts of the second sample data; Among them, the second grayscale compensation value is obtained through the following formula:

$${H}_{xb} = ln ( 1 + {H}_{x 3} - {H}_{x 2} )$$

$${H}_{x 3} = Sqrt [ \frac{1}{k} \cdot {\sum }_{i = 1}^{k} {( \frac{{H}_{si} - {H}_{b}}{{H}_{si}} - \frac{1}{n} \cdot {\sum }_{i = 1}^{k} \frac{{H}_{si} - {H}_{b}}{{H}_{si}} )}^{2} ]$$

Among them, Hxb represents the second grayscale compensation value; Hx3 represents the third compensation component; K represents the number of pixel blocks after the size of the pixel block is reduced; Hsi represents the grayscale value of the i-th pixel block after the size of the pixel block is reduced;
Comprehensive grayscale compensation value module: using the first grayscale compensation value and the second grayscale compensation value to obtain the comprehensive grayscale compensation value. Among them, the comprehensive grayscale compensation value is obtained through the following formula:

$${H}_{z} = ( 1 + \frac{{H}_{xb} - {H}_{xa}}{max ( {H}_{xb} , {H}_{xa} )} ) \cdot {H}_{p}$$

Among them, Hz represents the comprehensive grayscale compensation value; Hp represents the average grayscale value of the fingerprint portion of each fingerprint sample data.

The working principle of the above technical solution is to enlarge the pixel blocks of the fingerprint sample data used for initial training, and obtain the enlarged fingerprint sample data as the first sample data; Among them, the expanded size range of the pixel block is 1.5D-3D, where D represents the size of the pixel block used for initial training of fingerprint sample data; Obtain the first grayscale compensation value based on the grayscale values of the pixel blocks in the fingerprint and background parts of the first sample data; Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training; Obtain a second grayscale compensation value based on the grayscale values of pixel blocks in the fingerprint and background parts of the second sample data; Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training; Obtain a second grayscale compensation value based on the grayscale values of pixel blocks in the fingerprint and background parts of the second sample data; Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training; Obtain a second grayscale compensation value based on the grayscale values of pixel blocks in the fingerprint and background parts of the second sample data; Obtain a comprehensive grayscale compensation value using the first grayscale compensation value and the second grayscale compensation value. The working principle of the above technical solution is:
The effect of the above technical solution is that by changing the pixel block size as described above, the comprehensive grayscale compensation value can be obtained, which can effectively improve the accuracy of obtaining the comprehensive grayscale compensation value. By performing pixel block enlargement and reduction operations on fingerprint sample data, fingerprint image information at different scales can be obtained, enabling the system to capture the features and details of fingerprint images more comprehensively; By calculating the first grayscale compensation value and the second grayscale compensation value, the grayscale differences between the fingerprint and background parts at different scales are compensated for, thereby more accurately describing the grayscale features of the fingerprint image at different scales; By using the first grayscale compensation value and the second grayscale compensation value, the comprehensive grayscale compensation value can be calculated, which can comprehensively consider the grayscale features of fingerprint images at different scales, Improved the adaptability of fingerprint recognition systems to various scales of fingerprint images; By comprehensively utilizing multi-scale information and grayscale compensation values, the fingerprint recognition system has stronger robustness and accuracy when facing factors such as different scales and lighting conditions, which improves the practical application value of the system; By performing multi-scale processing on the initial training fingerprint sample data, more comprehensive and diverse data support can be provided for model training, which helps to improve the generalization ability and accuracy of fingerprint recognition systems. The above first grayscale compensation value formula considers multi-scale factors and grayscale value differences, comprehensively considers the grayscale features of the fingerprint and background parts, enhances the processing ability and accuracy of multi-scale fingerprint images, and helps to improve the robustness and accuracy of fingerprint recognition systems. At the same time, the first compensation component and the second compensation component in the formula respectively consider the difference in grayscale values before and after pixel block size expansion. By comparing the grayscale values of pixel blocks of different sizes, the grayscale changes of the fingerprint and background parts are more comprehensively described; The m and n parameters in the formula represent the number of pixel blocks after enlarging and reducing the pixel block size, respectively. By considering the grayscale values of pixel blocks at different scales, the grayscale compensation value can fully integrate the fingerprint image information at different scales, improving the system's processing capability for multi-scale fingerprint images; The Hb parameter in the formula represents the average grayscale value of the pixel blocks in the background. By introducing the grayscale value of the background into the calculation, the grayscale features of the fingerprint and background can be better distinguished, enhancing the accuracy of the grayscale compensation value. The sqrt operation in the formula is used to amplify and balance the differences in grayscale values, so that the grayscale compensation value can better reflect the grayscale changes at different scales, and improve the sensitivity of fingerprint image grayscale features. The above second grayscale compensation value calculation formula comprehensively considers multi-scale factors and grayscale value differences. By processing pixel block grayscale values at different scales, it enhances the processing capability and accuracy of multi-scale fingerprint images, which helps to improve the robustness and accuracy of fingerprint recognition systems. Meanwhile, the third compensation component Hx3 in the formula takes into account the difference in grayscale values after reducing the size of pixel blocks. By processing the grayscale values of the reduced size pixel blocks, it provides a more comprehensive description of the grayscale changes between the fingerprint and background parts. The k parameter in the formula represents the number of pixel blocks after reducing the pixel block size. By considering the grayscale values of pixel blocks at different scales, the second grayscale compensation value can fully integrate fingerprint image information at different scales, improving the system's processing capability for

The above comprehensive grayscale compensation value formula comprehensively considers the grayscale characteristics of fingerprint sample data, processes the grayscale information of fingerprint images globally, reduces the impact of individual samples on the system, helps improve the processing ability and accuracy of fingerprint recognition systems for different fingerprint samples, and enhances the robustness of the system. Meanwhile, the Hp parameter in the formula represents the average grayscale value of the fingerprint part of each fingerprint sample data. By introducing the average grayscale value of each fingerprint sample data, the comprehensive grayscale compensation value can consider the grayscale feature differences between different fingerprint samples, thereby enhancing the processing capability for different fingerprint samples. The comprehensive grayscale compensation value Hz processes the average grayscale value of the fingerprint part of each fingerprint sample data, taking into account the grayscale characteristics of the entire fingerprint image, so that the comprehensive grayscale compensation value can more comprehensively describe the grayscale changes between the fingerprint part and the background part. By introducing the average grayscale value of each fingerprint sample data, the formula can effectively process the grayscale features of individual samples, reducing the impact of individual samples on the entire system, improved the stability and robustness of the system.

### Example 9

In this embodiment, the image acquisition module comprises:
Grayscale value extraction module: Extract the grayscale values of pixel blocks in the input user's fingerprint reference image; Compensation value extraction module: Extract comprehensive grayscale compensation values;
Gray compensation value acquisition module: obtaining the first gray compensation amount corresponding to the gray compensation processing of the fingerprint reference image end through the gray values of the pixel blocks of the fingerprint reference image and the comprehensive gray compensation value; Among them, the first grayscale compensation amount is obtained through the following formula:

$${H}_{01} = ( 1 + \frac{1}{r \cdot {λ}_{1}} \cdot {\sum }_{i = 1}^{r} \frac{{H}_{ri} - {H}_{z}}{max ( {H}_{ri} , {H}_{z} )} ) \cdot {H}_{z}$$

$${λ}_{1} = 1 + \sqrt{\frac{1.312 \times {C}_{1}}{{C}_{2}}}$$

Among them, H01 represents the first grayscale compensation amount; R represents the number of pixel blocks in the fingerprint reference image; Hri represents the grayscale value of the i-th pixel block in the fingerprint reference image; Hz represents the comprehensive grayscale compensation value; C1 represents the number of pixel blocks in the fingerprint portion of the fingerprint reference image; C2 represents the number of pixel blocks in the background of the fingerprint reference image; λ1 represents the first adjustment coefficient;
Pixel block adjustment module: Adjust the pixel values of the fingerprint boundary pixel blocks of the fingerprint reference image to the first grayscale compensation amount, forming a grayscale compensated fingerprint reference image.
   The working principle of the above technical solution is to extract the grayscale values of pixel blocks in the reference image of the user's fingerprint that has been entered; The system will process the input user's fingerprint reference image, segment the image into different pixel blocks, and extract the grayscale value of each pixel block. These grayscale values reflect the brightness or grayscale level of each region in the fingerprint image; The extraction of comprehensive grayscale compensation values may involve analyzing the entire fingerprint reference image to determine the overall grayscale features and compensation requirements. This value may be calculated based on factors such as overall brightness and contrast of the image, and used for subsequent grayscale compensation processing. By combining the grayscale values of pixel blocks in the fingerprint reference image with the comprehensive grayscale compensation value, the system calculates the first grayscale compensation amount, which is usually used for grayscale adjustment of the entire image to achieve overall grayscale compensation processing. Finally, the system adjusts the pixel values of the fingerprint boundary pixel blocks in the fingerprint reference image to the first grayscale compensation amount, forming the fingerprint reference image after grayscale compensation processing. This step is equivalent to fine grayscale adjustment of local areas of the image to enhance the features of the fingerprint and improve the quality of the image.

The effect of the above technical solution is that by performing grayscale compensation processing on the fingerprint reference image, it can effectively reduce interference caused by external factors such as lighting conditions and influences, thereby improving the accuracy and robustness of fingerprint recognition; Grayscale compensation processing can help highlight and enhance features in fingerprint images, making them more discriminative and thus improving the reliability of fingerprint recognition; By adjusting the pixel values of the fingerprint reference image, grayscale compensation processing helps optimize the quality of the fingerprint image, making it clearer, easier to analyze, and recognize; The extraction of comprehensive grayscale compensation values and the adjustment of grayscale compensation amounts can be adjusted according to different environmental conditions and requirements, enabling the fingerprint recognition system to better adapt to different work scenarios. By using the first grayscale compensation calculation formula mentioned above, the calculation of grayscale compensation can be made more intelligent and personalized, which can better adapt to the characteristics of different fingerprint images and improve the performance of the entire fingerprint recognition system. Meanwhile, the above formula can be personalized and adjusted based on the specific features of the fingerprint reference image. By considering the number of pixel blocks in the fingerprint and background parts, the formula can compensate for the grayscale features of different parts to varying degrees, in order to adapt to the characteristics of different fingerprint images. The formula includes a comprehensive grayscale compensation value Hz, which enables the calculation of grayscale compensation to comprehensively consider the grayscale features of the entire fingerprint image, rather than being limited to the grayscale values of local areas. This can comprehensively adjust the grayscale of the image and improve the quality of the fingerprint image. The introduction of the adjustment coefficient λ1 makes the calculation of the grayscale compensation amount in the formula adjustable, and the parameters can be adjusted according to the actual situation to obtain the best grayscale compensation effect. Through this personalized, comprehensive and adjustable grayscale compensation calculation, the grayscale of the fingerprint reference image can be more accurately adjusted, thereby improving the accuracy and robustness of the fingerprint recognition system to fingerprint images.

### Example 10

In this embodiment, the image forming module comprises:
Detection module: Extract the grayscale values of pixel blocks in the fingerprint image to be detected; Extraction module: Extract comprehensive grayscale compensation values;
Acquisition module: Obtain the second grayscale compensation amount corresponding to the grayscale compensation processing of the image to be detected by using the grayscale values and comprehensive grayscale compensation values of the pixel blocks of the fingerprint image to be detected; Among them, the second grayscale compensation amount is obtained by the following formula:

$${H}_{02} = ( 1 + \frac{1}{r \cdot {λ}_{2}} \cdot {\sum }_{i = 1}^{r} \frac{{H}_{ri} - {H}_{z}}{max ( {H}_{ri} , {H}_{z} )} ) \cdot {H}_{z}$$

$${λ}_{2} = 1 + \sqrt{\frac{1.126 \times {C}_{3}}{{C}_{4}}}$$

Among them, H02 represents the second grayscale compensation amount; T represents the number of pixel blocks in the fingerprint image to be detected; Hti represents the grayscale value of the i-th pixel block of the fingerprint image to be detected; Hz represents the comprehensive grayscale compensation value; C3 represents the number of pixel blocks in the fingerprint portion of the fingerprint image to be detected; C4 represents the number of pixel blocks in the background of the fingerprint image to be detected; λ2 represents the second adjustment coefficient.

Image formation module: Adjust the pixel values of the fingerprint boundary pixel blocks of the fingerprint image to the second grayscale compensation amount to form the target fingerprint image to be detected.

The working principle of the above technical solution is to perform pixel block segmentation on the fingerprint image to be detected, with each pixel block containing a certain number of pixels. Then, extract the grayscale values of these pixel blocks. The grayscale value represents the color information of each pixel, ranging from 0 to 255, where 0 represents black and 255 represents white. This process is to obtain the brightness information of each pixel in the image; The extraction of comprehensive grayscale compensation values is to consider the brightness and contrast of the entire image. By processing various statistical features such as the average grayscale value, maximum and minimum grayscale values of the entire image. The comprehensive grayscale compensation value aims to provide reference for the subsequent grayscale compensation processing; By processing the grayscale values and comprehensive grayscale compensation values of the pixel blocks in the fingerprint image to be detected, the second grayscale compensation amount corresponding to the grayscale compensation processing of the image to be detected is obtained. This process usually involves some mathematical operations, such as addition, subtraction, multiplication, etc., to correct the grayscale value of each pixel; Adjust the pixel values of the fingerprint boundary pixel blocks in the fingerprint image to be detected to the second grayscale compensation amount.

The effect of the above technical solution is that by performing grayscale compensation processing on the fingerprint edge pixel blocks of the target fingerprint image to be detected, the grayscale values of the edge regions can be extracted, thereby enhancing the information of the fingerprint edges and making the boundaries of the target fingerprint image to be detected clearer and more accurate; By extracting the comprehensive grayscale compensation value and combining it with the grayscale values of the pixel blocks in the fingerprint image to be detected, the second grayscale compensation amount corresponding to the grayscale compensation processing on the image side can be calculated. This can achieve a balanced distribution of local grayscale in fingerprint images, resulting in smaller brightness differences and better visual effects for the entire image; Adjusting the pixel values of the fingerprint boundary pixel blocks in the fingerprint image to be detected to the second grayscale compensation amount can effectively correct the grayscale differences in the edge area, further enhancing the quality and clarity of the target fingerprint image to be detected, and providing more accurate input for subsequent fingerprint recognition. The above formula combines the pixel block grayscale values, comprehensive grayscale compensation values, and adjustment coefficients of the fingerprint image to be detected. It can personalize grayscale compensation, adjust grayscale distribution, distinguish background and fingerprint, and flexibly control the grayscale compensation effect through adjustment coefficients, thereby improving the quality and reliability of the target fingerprint image to be detected. Meanwhile, the above formula is based on the grayscale values of the pixel blocks in the fingerprint image to be detected. Hti in the formula represents the grayscale value of each pixel block. By summing up all pixel blocks and dividing by the number of pixel blocks t, the average grayscale value can be obtained. This can more accurately reflect the grayscale features of the entire fingerprint image, thereby achieving personalized grayscale compensation; The comprehensive grayscale compensation value Hz plays a role in adjusting the grayscale distribution in the formula. By comprehensively considering the local grayscale features and overall grayscale compensation values of the fingerprint image to be detected, appropriate grayscale adjustments can be made to different regions according to specific situations, thereby improving the visual effect of the entire image; C3 and C4 in the formula respectively represent the number of pixel blocks in the fingerprint and background parts of the fingerprint image to be detected. By considering the influence of the background in the calculation, it is possible to better distinguish between fingerprints and backgrounds, further improving the clarity and of the target fingerprint image to be detected; The adjustment coefficient λ2 plays a role in adjusting the grayscale compensation amount in the formula. By adjusting the values of the coefficients, the intensity and effect of grayscale compensation can be flexibly controlled to meet different practical application needs.

Obviously, technicians in this field can make various modifications and variations to the present invention without departing from the spirit and scope of the invention. Thus, if these modifications and variations of the present invention fall within the scope of the claims and their equivalent technologies, the present invention is also intended to include these modifications and variations.

1.-10. (canceled)

11. A deep learning based fingerprint image recognition method, characterized in that the fingerprint image recognition method comprises:
Perform grayscale compensation on the fingerprint boundary pixel blocks of the fingerprint sample data in the database, and use the grayscale compensated fingerprint sample data and the original fingerprint sample data for two rounds of deep learning model training to complete the trained deep learning model;
Perform grayscale compensation processing on the fingerprint boundary pixel blocks of the input user's fingerprint reference image, obtain the grayscale compensated fingerprint reference image, and use the deep learning model to obtain the fingerprint features of the fingerprint reference image as the target fingerprint features;
When obtaining the user's fingerprint image to be detected, perform grayscale compensation processing on the edge pixel blocks of the fingerprint image to form the target fingerprint image to be detected;
Inputting the target fingerprint image to be detected into a deep learning model, the deep learning model obtains the target fingerprint image for fingerprint feature recognition, obtains the fingerprint features of the target fingerprint image, and compares the fingerprint features of the target fingerprint image with the target fingerprint features to obtain the fingerprint image recognition result;
Extract fingerprint sample data from the database, and use the fingerprint sample data to perform initial training on the deep learning model used for fingerprint image feature recognition, obtaining the initial deep learning model after completing the initial training;
Perform pixel block enlargement and pixel block reduction on the fingerprint sample data used for initial training, and obtain the comprehensive grayscale compensation value corresponding to the fingerprint sample data used for initial training by expanding and reducing the pixel block of the fingerprint sample data;
By using the comprehensive grayscale compensation value to perform grayscale compensation processing on the fingerprint boundary pixel blocks of the fingerprint sample data used for initial training, the adjusted sample data is obtained;
Using the adjusted sample data to perform secondary training on the deep learning model and obtain the trained deep learning model;
Using fingerprint validation samples to validate the deep learning model and obtain the accuracy of fingerprint image feature recognition of the deep learning model;
When the accuracy is lower than the preset accuracy threshold, optimize the deep learning model until the validated accuracy reaches or exceeds the preset accuracy threshold.

12. The deep learning based fingerprint image recognition method according to claim 11, characterized in that pixel block enlargement and pixel block reduction are performed on the fingerprint sample data used for initial training, and the comprehensive grayscale compensation value corresponding to the fingerprint sample data used for initial training is obtained by enlarging and reducing the pixel block of the fingerprint sample data, comprising:
Expand the pixel blocks of the fingerprint sample data used for initial training to obtain the enlarged fingerprint samples data, as the first sample data; Among them, the expanded size range of the pixel block is 1.5D-3D, where D represents the size of the pixel block used for initial training of fingerprint sample data;
Obtain the first grayscale compensation value based on the grayscale values of the pixel blocks in the fingerprint and background parts of the first sample data;
Reduce the pixel blocks of the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training;
Obtain a second grayscale compensation value based on the grayscale values of pixel blocks in the fingerprint and background parts of the second sample data; Obtain a comprehensive grayscale compensation value using the first grayscale compensation value and the second grayscale compensation value.

13. The deep learning based fingerprint image recognition method according to claim 11, characterized in that the fingerprint boundary pixel blocks of the input user's fingerprint reference image are subjected to grayscale compensation processing at the fingerprint reference image end to obtain a grayscale compensated fingerprint reference image, comprising:
Extract the grayscale values of pixel blocks from the fingerprint reference image of the user that has been entered; Extract comprehensive grayscale compensation value;
Obtain the first grayscale compensation amount corresponding to the grayscale compensation processing at the fingerprint reference image end by using the grayscale values and comprehensive grayscale compensation values of the pixel blocks in the fingerprint reference image;
Adjust the pixel values of the fingerprint boundary pixel blocks of the fingerprint reference image to the first grayscale compensation amount to form the fingerprint reference image after grayscale compensation processing.

14. The deep learning based fingerprint image recognition method according to claim 11, characterized in that, when obtaining the user's fingerprint image to be detected, the fingerprint edge pixel blocks of the fingerprint image to be detected are subjected to grayscale compensation processing at the image end to form the target fingerprint image to be detected, comprising:
Extract the grayscale values of pixel blocks in the fingerprint image to be detected;
Extract comprehensive grayscale compensation value;
Obtain the second grayscale compensation amount corresponding to the grayscale compensation processing of the image to be detected by using the grayscale values and comprehensive grayscale compensation values of the pixel blocks in the fingerprint image to be detected;
Adjust the pixel values of the fingerprint boundary pixel blocks of the fingerprint image to the second grayscale compensation amount to form the target fingerprint image to be detected.

15. A deep learning based fingerprint image recognition system, characterized in that the fingerprint image recognition system comprises:
Data processing module: perform grayscale compensation on the fingerprint boundary pixel blocks of the fingerprint sample data in the database, and use the grayscale compensated fingerprint sample data and the original fingerprint sample data to train the deep learning model twice, completing the trained deep learning model;
Image acquisition module: Perform fingerprint reference image processing on the fingerprint boundary pixel blocks of the input user's fingerprint reference image grayscale compensation processing is used to obtain the fingerprint reference image after grayscale compensation processing, and the fingerprint features of the fingerprint reference image are obtained through the deep learning model as the target fingerprint features;
Image formation module: When obtaining the user's fingerprint image to be detected, perform grayscale compensation processing on the fingerprint edge pixel blocks of the fingerprint image to form the target fingerprint image to be detected;
Result acquisition module: Input the target fingerprint image to a deep learning model, which obtains the target fingerprint image for fingerprint feature recognition, obtains the fingerprint features of the target fingerprint image, and compares the fingerprint features of the target fingerprint image with the target fingerprint features to obtain the fingerprint image recognition result;
The data processing module comprises:
Data extraction module: Extract fingerprint sample data from the database, and use the fingerprint sample data to perform initial training on the deep learning model used for fingerprint image feature recognition, obtaining the initial deep learning model after completing the initial training;
Compensation value acquisition module: pixel block enlargement and pixel block reduction are performed on the fingerprint sample data used for initial training, and the comprehensive grayscale compensation value corresponding to the fingerprint sample data used for initial training is obtained by enlarging and reducing the pixel block of the fingerprint sample data;
Data acquisition module: using the comprehensive grayscale compensation value to perform grayscale compensation processing on the fingerprint boundary pixel blocks of the fingerprint sample data used for initial training, and obtain adjusted sample data;
Model acquisition module: Use the adjusted sample data to perform secondary training on the deep learning model and obtain the trained deep learning model;
Accuracy acquisition module: using fingerprint validation samples to validate the deep learning model and obtain the accuracy of fingerprint image feature recognition of the deep learning model;
Threshold judgment module: When the accuracy is lower than the preset accuracy threshold, optimize the deep learning model until the validated accuracy reaches or exceeds the preset accuracy threshold.

16. The fingerprint image recognition system based on deep learning according to claim 15, characterized in that the compensation value obtaining module comprises:
First sample data module: pixel block enlargement is performed on the fingerprint sample data used for initial training to obtain the enlarged fingerprint sample data as the first sample data; Among them, the expanded size range of the pixel block is 1.5D-3D, where D represents the size of the pixel block used for initial training of fingerprint sample data;
The first grayscale compensation value module obtains the first grayscale compensation value based on the grayscale values of the pixel blocks in the fingerprint and background parts of the first sample data;
Second sample data module: perform pixel block reduction on the fingerprint sample data used for initial training, obtain the reduced pixel block fingerprint sample data, and use it as the second sample data; Among them, the reduced size range of the pixel block is 0.1D-0.5D, where D represents the size of the pixel block of the fingerprint sample data used for initial training;
Second grayscale compensation value module: obtaining a second grayscale compensation value based on the grayscale values of pixel blocks in the fingerprint and background parts of the second sample data;
Comprehensive grayscale compensation value module: using the first grayscale compensation value and the second grayscale compensation value to obtain the comprehensive grayscale compensation value.

17. The fingerprint image recognition system based on deep learning according to claim 16, characterized in that the image acquisition module comprises:
Grayscale value extraction module: Extract the grayscale values of pixel blocks in the input user's fingerprint reference image; Compensation value extraction module: Extract comprehensive grayscale compensation values;
Gray compensation value acquisition module: obtaining the first gray compensation amount corresponding to the gray compensation processing of the fingerprint reference image end through the gray values of the pixel blocks of the fingerprint reference image and the comprehensive gray compensation value;
Pixel block adjustment module: Adjust the pixel values of the fingerprint boundary pixel blocks of the fingerprint reference image to the first grayscale compensation amount, forming a grayscale compensated fingerprint reference image.

18. The fingerprint image recognition system based on deep learning according to claim 15, characterized in that the image forming module comprises:
Detection module: Extract the grayscale values of pixel blocks in the fingerprint image to be detected; Extraction module: Extract comprehensive grayscale compensation values;
Acquisition module: Obtain the second grayscale compensation amount corresponding to the grayscale compensation processing of the image to be detected by using the grayscale values and comprehensive grayscale compensation values of the pixel blocks of the fingerprint image to be detected;
Image formation module: Adjust the pixel values of the fingerprint boundary pixel blocks of the fingerprint image to the second grayscale compensation amount to form the target fingerprint image to be detected.
